(19) United States
(12) Patent Application Publication
(10) Pub. No.: US 2009/0064832 A1
(43) Pub. Date: Mar. 12, 2009

(54) Cutting Unit With Modular Structure

(76) Inventors: Eros Caretta, Sarcedo (IT); Mirko Caretta, Sarcedo (IT); Herbert Caretta, Sarcedo (IT); Ruben Caretta, Sarcedo (IT)

Correspondence Address: James V. Costigan, 1185 Avenue of the Americas, New York, NY, 10036, US

(21) Appl. No.: 12/083,133

(22) PCT Filed: Oct. 9, 2006
(86) PCT No.: PCT/IB2006/002812

§ 371 Date: May 20, 2008

(30) Foreign Application Priority Data
Oct. 7, 2005 (IT) VI2005A000262
Feb. 28, 2006 (IT) VI2006A000054

(51) Int. Cl. B26D 5/20

(52) U.S. Cl. 83/76.7

(57) ABSTRACT

A cutting unit with modular structure, comprising a machine (10), shaped with one or more bridges (11) and managed by a numeric control management software, which can use one or more respective cutting heads (15), suitable for moving in two or three dimensions and angularly in space, so as to carry out multiple processing operations and types of cut, such as water jet or hydroabrasive cutting, laser cutting and/or plasma cutting and/or oxycutting and/or “milling” chip removal; the machine (10) in question, thanks to the particular design in modules (26) and/or to one or more opposite working bridges (11), allows the maximum flexibility and personalisation, according to the client's requirements.

The present invention refers, in general, to industrial cutting units, which use various technologies to carry out the cutting and/or incision operations, such as concentrated jets of fluid, in particular water, at high speed, hydroabrasive cutting, laser cutting, plasma cutting, oxycutting and/or chip removal methods known as “milling”.

More specifically, the invention concerns a unit comprising a highly flexible and innovative cutting machine, since it is suitable for carry out multiple types of processing and cutting and/or incision, like shapes and designs, even substantially complex ones, with a high degree of precision and efficiency, minimising the possibility of causing damage to the substrate during the cutting and/or incision operation; in particular, thanks to the particular modular design, capable of allowing the maximum flexibility and personalisation according to the client's requirements, the machine can also be easily expanded at a later time, both two-dimensionally and three-dimensionally, thanks to the addition of additional modules, to increase the useful working area, with highly contained costs.

Amongst the types of industrial cutting currently available, high pressure waterjet cutting certainly represents the most innovative and futuristic technology introduced onto the market in the last few years, since it is able to optimise the cutting processes on a vast range of materials.

A conventional waterjet cutting apparatus typically comprises means suitable for supporting the material to be cut and/or incised, special nozzles, mounted on respective cutting heads, suitable for directing the jet of water or other fluid against the material to be cut and/or incised, actuation and control devices, suitable for carrying out the relative movement between the nozzle and the material to be cut and/or incised usually along two perpendicular axes, and dissipater means, which receive the jet of fluid and dissipate the energy produced, after the jet has penetrated through the material for the cutting and/or incision operation. The apparatus can also comprise support means, suitable for compressing the substrate on which the cutting and/or incision operation is carried out, in the case in which the material to be cut has a particularly flexible consistency, in order to avoid undesired movements of the substrate during the operation.

In most known fluid jet cutting units and, in particular, in those that must carry out particularly complex cutting and/or incision operations with a high degree of precision, the cutting heads, which carry the respective high pressure nozzles, are normally mounted so that their motion, during the cutting operation, can be controlled on two perpendicular axes, whereas the material being processed is placed on the support in fixed position.

However, since in an apparatus of this type the nozzle, positioned above the material being processed, is forced to move in a relatively large space, the containment and dissipation of the energy deriving from the action of the high pressure fluid jet on the material to be cut can represent clear technical problems.

A solution could be to increase the number of nozzles operating, however the operating cost of such a type of unit is rather high.

Moreover, there is an ever-increasing need to make cutting machines and units that are extremely flexible, i.e. suitable for being personalised to suit the client, both in terms of the dimensions of the useful working area, in the two-dimensional and three-dimensional sense, and in terms of the type of cutting to be carried out, so as to totally satisfy the client's requirements.

The purpose of the present invention is, therefore, to avoid the aforementioned drawbacks and, in particular, to make a cutting unit with modular structure, which is highly flexible and able to be personalised according to the client's requirements, both in terms of the processing that can be carried out and the useful working areas, and in terms of the types of cutting that can be carried out.

Another purpose of the present invention is to make a cutting unit with modular structure, which is highly reliable and efficient from the functional point of view and with relatively low costs, with respect to conventional known units, in virtue of the advantages obtained.

These and other purposes are accomplished by a cutting unit with modular structure, according to the attached claim 1; the further dependent claims include other detailed technical characteristics.

Further characteristics and advantages of the present invention shall become clearer from the following description, relative to a preferred but not limiting example embodiment, and from the attached drawings, in which:

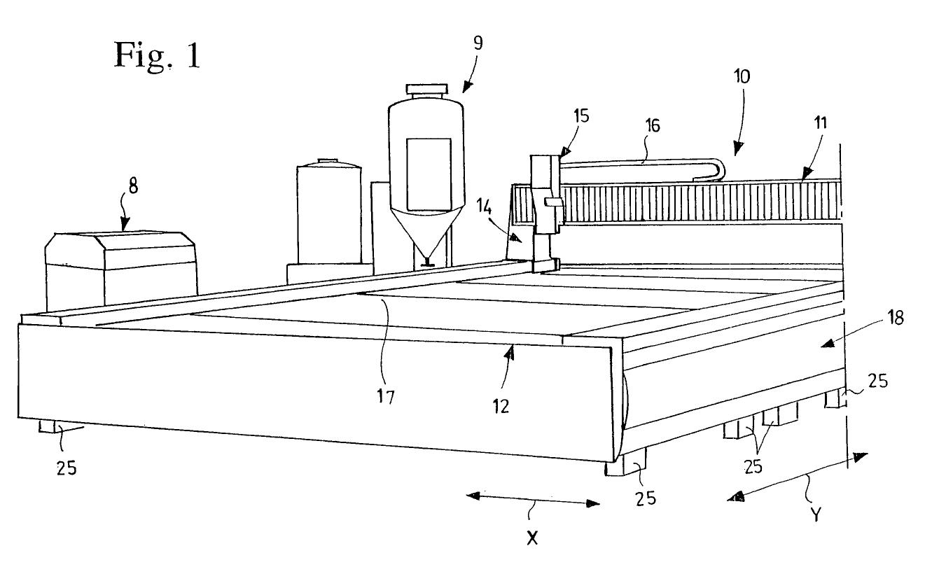

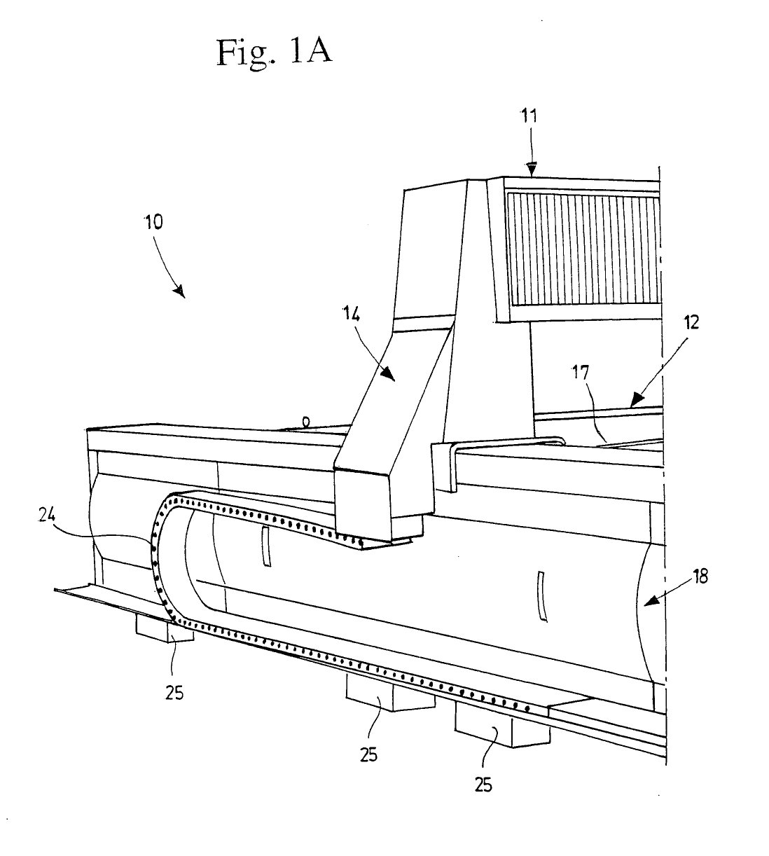

FIGS. 1 and 1A represent partial perspective views of a first embodiment of a cutting machine able to be used in a cutting unit with modular structure, according to the present invention;

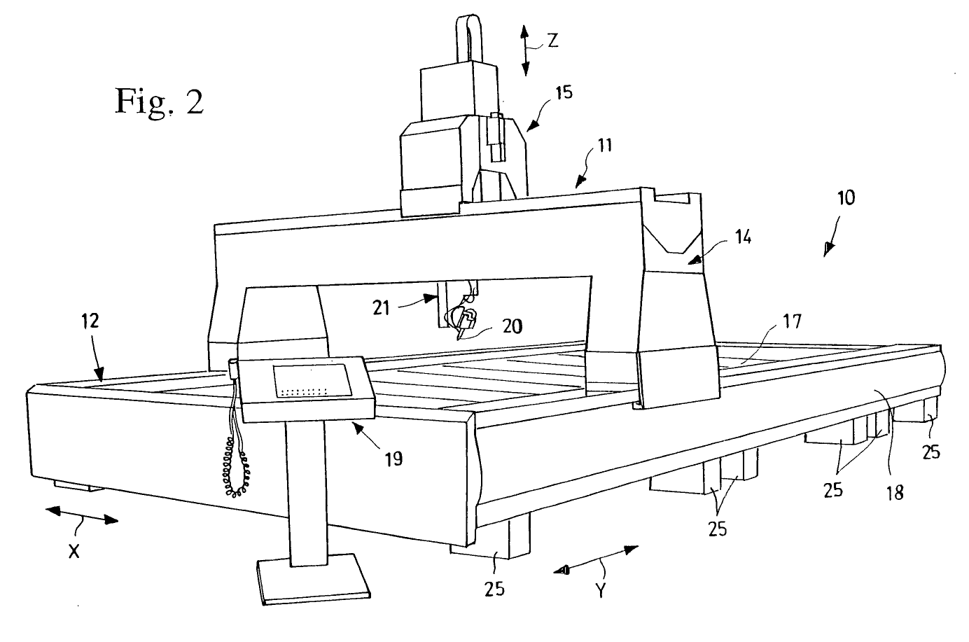

FIG. 2 is a perspective view of a second embodiment of a cutting machine able to be used in a cutting unit with modular structure, according to the present invention;

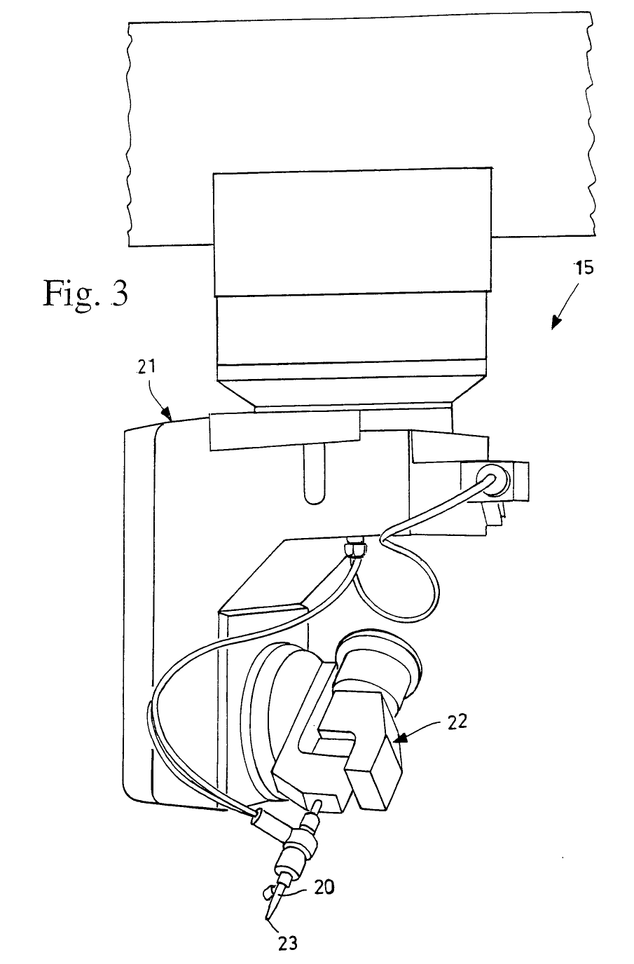

FIG. 3 shows an enlarged detail of the cutting machine according to FIG. 2, able to be used in a cutting unit with modular structure, according to the present invention;

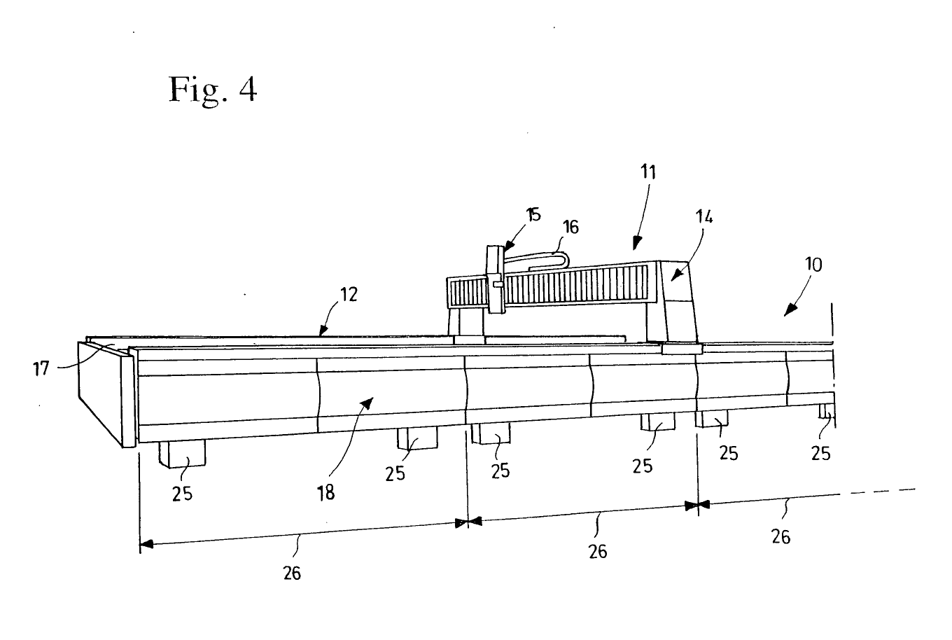

FIG. 4 shows a side view of the cutting machine according to FIG. 1, able to be used in a cutting unit with modular structure, according to the present invention;

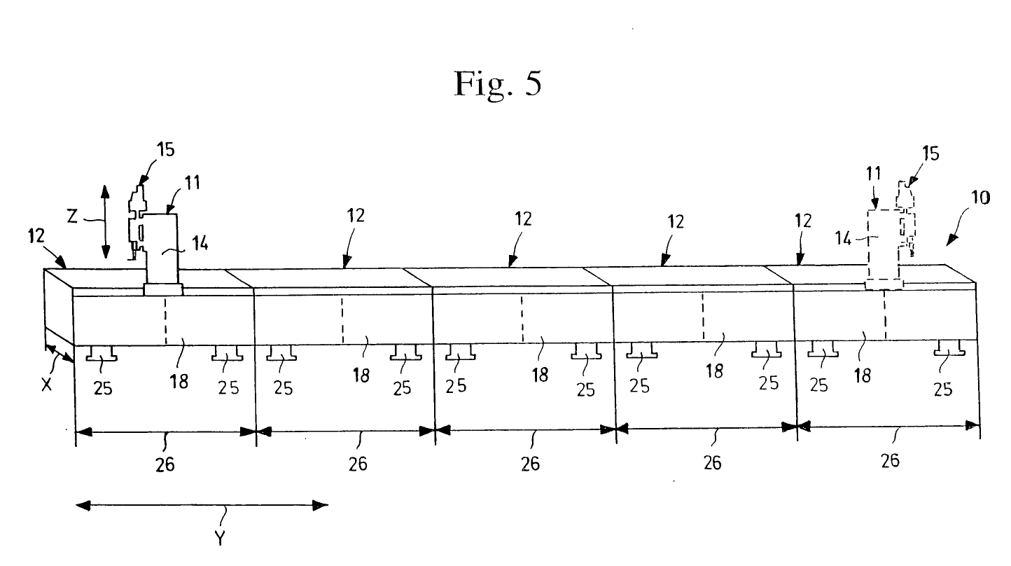

FIG. 5 is a schematic side view of the cutting machine according to FIG. 1, able to be used in a cutting unit with modular structure, according to the present invention;

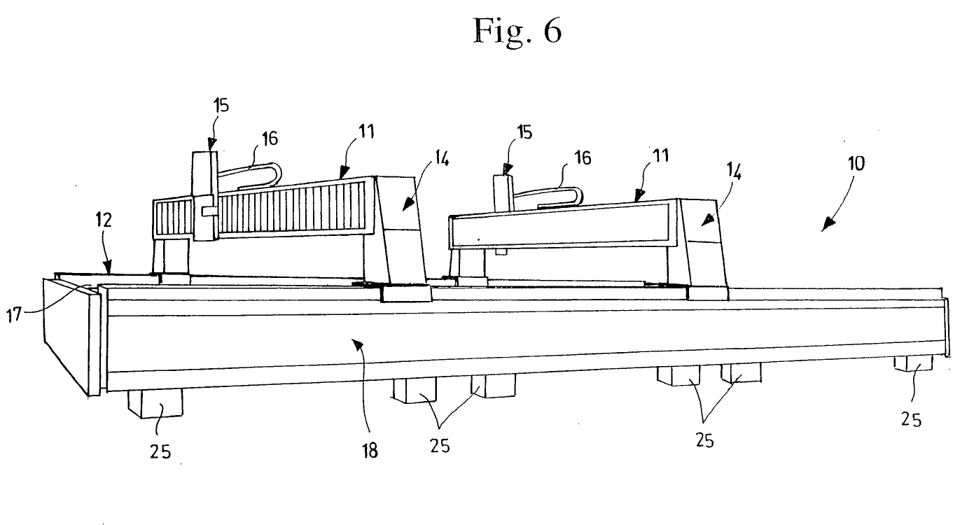

FIG. 6 is a perspective view of a third embodiment of a cutting machine able to be used in a cutting unit with modular structure, according to the present invention.

With reference to the aforementioned figures, the cutting unit with modular structure, according to the present invention, is essentially made up of a cutting machine 10, with substantially flat structure, on the work plane 12 of which at least one bridge structure 11 is positioned, which translates longitudinally on the plane 12 of the machine 10, thanks to the movement of a toothed rack 24, arranged on the side of the plane 12, on the walls of the containment tank 18, which actuates the support structure 14 of the bridge 11 along the axis Y.

On each bridge structure 11 at least one cutting head 15 is positioned, also moved at least in translation along the axis X, in a direction transversal to the plane 12, by means of a toothed rack 16 for the distribution of motion, which allows processing to be carried out on the pieces distributed on the work plane 12, or rather on a support grid 17 for the pieces, dismountable and able to be positioned on the work plane 12, according to the processing to be carried out on the pieces, by means of the cutting head 15 (FIG. 1).

FIG. 2 shows in detail an alternative embodiment of a cutting machine 10, in which the cutting head 15 is suitable for being moved both in a direction (direction X) transversal to the direction in which the support structure 14 of the bridge 11 advances on the plane 12 (direction Y), and in a direction (direction Z) vertical to the plane 12 itself, in order to carry out any type of processing in three dimensions; such a cutting machine can also be used in robotized booths for cutting in three dimensions (in the case of a fixed cutting head 15) or five dimensions (in the case of a cutting head 15 mobile in three dimensions).

In general, as stated, the cutting head 15 includes a support structure 21, mobile in one, two or three dimensions, to which a nozzle 20 for waterjet cutting can be fixed, in which case the head 15 is built so as to eliminate the need to carry out the centring of the waterjet with the localiser (FIG. 3); alternatively, the cutting head 15 can include the support structure 21 for further cutting devices, in order to carry out laser cutting and/or plasma cutting and/or oxycutting and/or milling and/or combined cutting operations, such as waterjet cutting+laser cutting, laser cutting+plasma cutting, laser cutting+oxycutting, etc.

In particular, in the case of use of the waterjet cutting unit, the head 15 is ready prepared for the mounting of devices 22 for the focalized jet, which ensure high performance and constancy in the quality of the jet for a long time (FIG. 3), whereas the support grid 17 of the pieces is made from stainless steel and dismountable by individual blades, so as to be able to replace only the parts worn by the jet, and the containment tank 18, lifted from the ground thanks to the clamps 25, is prepared for connection to a recovery, sedimentation and separation system of the muds from the abrasive material.

Indeed, in waterjet cutting, the particular constructive concept of the cutting head 15 eliminates the need to carry out the centring of the waterjet with the focalizer and, moreover, such a head 15 is made so as to allow the replacement of the components without using special keys; a rotation by ¼ of a turn is all that is needed to separate the group 22 and, therefore, minimise the maintenance time as much as possible.

The cutting head 15 is also prepared for the mounting of “long life” focalizers, which ensure the high performance and constancy in quality of the jet for a long time.

Furthermore, in the case in which the machine 10 per for waterjet cutting is used, the entire unit (FIGS. 1-3) is completed by a group of volumetric pumps, actuated by a pressure-intensifying device 8, with high reliability standards, that is easy to use, simple to install and has low operating and maintenance costs, and by a closed circuit purification system 9 of the waste water for purifying the cutting water, which allows the recirculation and reuse thereof, ensuring a lowering of the operating costs of the system, the possibility of avoiding an external water supply, constancy of the quality of the water supplied by the pump and a longer lifetime of the gaskets, “check valves” and of all of the high-pressure components, with consequent lower wear thereof, less maintenance and changing of parts, and ensuring the absence of problems relative to the disposal of polluted waste water from processing (also since totally natural inert minerals, and not dangerous materials, are used as abrasive materials, and, moreover, the absence of fumes and dusts ensures a healthier working environment, compared to known systems).

As stated, very high pressure waterjet cutting is able to optimise the cutting processes for an infinite range of materials and the energy necessary for cutting is obtained by conveying a high pressure flow of water (up to 417.3 Mpa, i.e. 60,000 psi) through the suitably sized outlet hole 23 of the nozzle 20, producing a coherent jet at double the speed of sound.

The jet, which can have abrasive material added to it depending upon the material to be cut, is directed onto the surface of the piece being processed and causes the separation of the parts through a dual combined cutting and abrasion action.

In any case, for any type of cutting of the machine 10, be it with water, with laser and/or with plasma, oxycutting and/or milling, the unit, according to the present invention, includes a new generation numeric control work centre 19, which works under Windows®, using two powerful processors (FIG. 2).

The numeric control centre 19 (“CNC”), as well as managing the digital actuations, which govern movement, is able to offer a graphically attractive man-machine interface that is easy to understand and extremely intuitive.

Moreover, the technological management software resident on “CNC” for managing the quality and speed of cutting, in relation to the different type of materials and the thickness thereof, allows automatic management of the acceleration ramps and of the slowing down at the edges, management of the cutting attachments and management of the perforation cycles to be carried out. Finally, the control system of the unit offers the instruments necessary to carry out all of the foreseen technological applications, like the multiple types of cutting (from waterjet cutting to laser cutting, to plasma cutting, oxycutting, milling) and the further processing that can be performed, which can therefore coexist, thus making a flexible and innovative unit.

A further important characteristic of the unit according to the invention, which increases it maximum flexibility and personalisation, according to the client's requirements, is the particular modular design of the machine 10, as illustrated in detail in the attached FIGS. 4 and 5.

Indeed, the machine 10 can be easily expanded at a later time, thanks to the possibility of adding additional modules (indicated with 26 in FIGS. 4 and 5), each equipped with a bridge structure 11 equipped with a cutting head 15, in order to increase the useful working area, at the same time keeping the production, maintenance and operating costs low.

The modular structure, overall, allows the machine 10 to be lengthened or shortened, according to the size and volume of the pieces that the company usually cuts, without losing anything in terms of flexibility of use, since the machine 10 can be equipped analogously with various cutting heads 15, suitable for carrying out water cutting, laser cutting and/or plasma cutting, and/or oxycutting and/or milling and/or combined cutting.

In further alternative embodiments of the cutting unit according to the invention it is also foreseen to make machines 10 with opposite double bridge 11, as can be seen in FIG. 6.

The particular type of machine 10 with opposite double bridge, together with the possibility of carrying out numerous and different types of cuts, even combined with each other, and the possibility of designing the machine 10 in modules, as described previously, allows units to be made that can be completely personalised to suit the client's needs and, specifically, the opposite double bridge allows double processing to be carried out while the machine is running (even on different profiles), allows different technologies to be used applied on different trollies (for example, one bridge 11 for cutting on 3 axes+one bridge 11 for cutting on 5 axes, using a 3-dimensional cutting head 15), allows a single or double trolley to be used (indeed, by placing a bridge 11 on stand-by the processing is made available on all the surface possible) and allows an opposite machine set value (reference position) to be made.

From the description that has been made the characteristics of the cutting unit with modular structure, object of the present invention, are clear, just as its advantages are also clear.

Finally, it is clear that numerous other variants can be brought to the cutting unit in question, without for this reason departing from the novelty principles inherent to the inventive idea, just as it is clear that, in the practical embodiment of the invention, the materials, the shapes and the sizes of the illustrated details can be whatever according to the requirements and they can be replaced with others that are technically equivalent.

1. Cutting unit with modular structure, of the type comprising at least one cutting machine (10), which foresees at least one bridge structure (11), on which at least one cutting head (15) is installed, suitable for performing processing on pieces arranged on at least one work plane (12) below, the moving and actuation of said at least one bridge structure (11) and of said at least one cutting head (15) being commanded by means of a numeric control work centre (19), managed by an application software programme and able to be used to set and display the parameters, characterised in that said cutting head (15) includes means suitable for waterjet or hydroabrasive cutting, lasercutting and/or plasma cutting and/or oxycutting and/or milling and/or combinations of said types of cutting, so as to be able to carry out multiple types of processing and/or types of cutting, allowing the maximum flexibility and personalisation according to the client's requirements.

2. Cutting unit according to claim 1, characterised in that said work plane (12) is contained inside at least one containment structure (18), said containment structure (18) being made from modules (26), so as to obtain the maximum flexibility and personalisation, according to the size and volume of the pieces being processed, said machine (10) thus being able to be expanded at a later time, thanks to the possibility of adding additional modules (26), increasing the useful working area and, at the same time, keeping the production, maintenance and operating costs low.

3. Cutting unit according to claim 1, characterised in that each bridge structure (11) translates longitudinally (Y) on said work plane (12) of the machine (10), thanks to the movement of at least one first toothed rack (24), which actuates at least one support element (14) of the bridge structure (11).

4. Cutting unit according to claim 3, characterised in that said cutting head (15) is moved in translation on said bridge structure (11), by means of at least one second toothed rack (16) for distribution of motion, in a direction (X) transversal to the direction (Y) in which said support element (14) of the bridge structure (11) advances.

5. Cutting unit according to claim 4, characterised in that said cutting head (15) is suitable for being moved in the vertical direction (Z) perpendicular to said work plane (12) of the machine (10) and/or angularly in space, in order to carry out processing in at least three dimensions.

6. Cutting unit according to claim 1, characterised in that said work plane (12) includes at least one dismountable grid (17), to support the pieces being processed, and characterised in that said containment structure (18) is arranged for connection to a system for recovery and purification (9) of the waste water.

7. Cutting unit according to claim 1, characterised in that said cutting machine (10) uses at least two opposite bridge structures (11), so as to carry out double processing while the machine is running, even on different profiles, use different technologies applied on different trollies, use a single or double trolley and/or make at least opposite reference positions (machine set values).

8. Cutting unit according to claim 2, characterised in that said modularity allows the use of the machine to be easily converted, thanks to the technological flexibility thereof, both in terms of the types of cut that can be carried out and in terms of the dimensions, two-dimensional and/or three-dimensional and/or for all of the possible angular positions, of the cutting area.

9. Cutting unit with modular structure as substantially described and illustrated in the attached drawings and for the specified purposes.
